(19) United States
(12) Patent Application Publication
(10) Pub. No.: US 2005/0236496 A1
(43) Pub. Date: Oct. 27, 2005

(54) Nozzle for a washing system for vehicle windows, and washing unit

(75) Inventor: Uwe Lasebnick, Ditzingen (DE)

Correspondence Address: OSHA LIANG L.L.P., 1221 MCKINNEY STREET, SUITE 2800, HOUSTON, TX, 77010, US

(73) Assignee: Valeo Wischersysteme GmbH, Bietigheim-Bissingen (DE)

(21) Appl. No.: 10/523,906

(22) PCT Filed: Jul. 28, 2003
(86) PCT No.: PCT/EP03/08293

§ 371 Date: Jan. 28, 2005

(30) Foreign Application Priority Data
Jul. 31, 2002 (DE) 102 34 871.5

(51) Int. Cl. B05B 1/10

(52) U.S. Cl. 239/284.1

(57) ABSTRACT

The invention relates to a nozzle and a washing system in particular for vehicle windscreens, comprising a nozzle body with a receiving device provided in the nozzle body, into which receiving device a nozzle insert is or can be inserted, wherein the nozzle insert influences the jet form of a liquid jet leaving the nozzle. The invention is characterized in that the receiving device has at least two inlets for the cleaning liquid and in that the nozzle insert is designed such that it influences the cleaning liquid coming from one inlet in a different manner from the cleaning liquid coming from another inlet.

The invention relates to a nozzle for a washing system and to a washing system in particular for vehicle windscreens, comprising a nozzle body with a receiving device provided in the nozzle body, into which receiving device a nozzle insert is or can be inserted, wherein the nozzle insert influences the jet form of a liquid jet leaving the nozzle. Such a nozzle is known from U.S. Pat. No. 5,636,794. Such a nozzle has a connection which can be connected to a conveying pump and is connected to a nozzle opening formed by the nozzle insert and the wall adjoining the nozzle insert.

Based on this prior art, it is an object of the invention to provide a nozzle which allows various jet forms of a liquid jet leaving the nozzle. Moreover, a washing system comprising such a nozzle is to be provided.

This object is achieved in that the receiving device has at least two inlets for the cleaning liquid and in that the nozzle insert is designed such that it influences the cleaning liquid coming from one inlet in a different manner from the cleaning liquid coming from another inlet. This has the advantage that different liquid jets can be produced with one and the same nozzle insert depending on the inlet via which cleaning liquid flows into the receiving device or into the respective chamber formed by the receiving device and the nozzle insert. It is conceivable for the number of inlets to correspond to the number of possible liquid jets to be produced.

It is particularly advantageous if the nozzle body can be fitted with different nozzle inserts during assembly of the nozzle. As a result, the nozzle body can be manufactured as a standard component and provided with appropriately designed nozzle inserts depending on the requirement in terms of the vehicle windscreen to be sprayed or the vehicle. Huge cost advantages can thereby be achieved, particularly in mass production.

Advantageously, the nozzle insert is designed such that the cleaning liquid coming from one inlet is influenced such that one or more punctiform jet forms can be produced. It is likewise advantageous if the nozzle insert influences the cleaning liquid coming from at least one, in particular another, inlet such that one or more flat, curved and/or conical jet forms can be produced.

It is particularly advantageous here if two inlets are provided, wherein the nozzle insert influences the cleaning liquid coming from one inlet such that punctiform jet forms are produced and that the nozzle insert influences the cleaning liquid coming from the other inlet such that flat, curved and/or conical jet forms can be produced.

According to the invention, it is also conceivable that the nozzle insert blocks the cleaning liquid coming from one inlet. Such a nozzle insert may be used for example when two inlets are provided but only one type of jet form is to be produced.

In order to avoid mixing of the cleaning liquid coming from one inlet with a cleaning liquid coming from another inlet, the nozzle insert is advantageously designed such that it separates the cleaning liquids coming from the inlets.

Moreover, it is advantageous if the nozzle insert together with at least one wall facing said insert forms a chamber which influences and/or guides the cleaning liquid. The chamber may in particular be a whirl chamber and/or a jet guide. A whirl chamber is advantageous if the jet to be provided is not a punctiform jet but rather a linear or flat jet. A jet guide is required when a punctiform jet is to be produced.

One particularly advantageous embodiment has been found to be when the nozzle insert together with a wall of the receiving device facing said insert forms a whirl chamber connected to the inlet and at least one jet guide to a first nozzle opening. The nozzle opening is advantageously delimited on one side by the nozzle insert and on the other side by the corresponding wall of the receiving device.

It is also conceivable according to the invention that the nozzle insert on one side has a whirl chamber with a jet guide, and that the nozzle insert on another side, in particular on the side opposite the first side, has a second whirl chamber with a second jet guide, wherein the first whirl chamber is connected to a first inlet and the second whirl chamber is connected to a second inlet.

One advantageous embodiment of the invention provides that the nozzle insert has a break-away edge, in particular for producing a flat jet. This has the advantage that only the nozzle insert has to be manufactured with relatively high accuracy in order to produce a precisely defined break-away edge. The nozzle body as such is not affected thereby and can have conventional tolerances.

It is advantageous if the inlets in the receiving device run essentially perpendicular to the main jet direction of the jet forms to be produced. This allows a very slim and compact geometry of the nozzle.

It is advantageously conceivable that the nozzle insert has essentially a cuboid shape. In a manner corresponding to the shape of the nozzle insert, the receiving device will then also have essentially a cuboid shape. This has the advantage that simple and easy insertion of the nozzle insert into the receiving device is possible.

Preferably, the nozzle insert is made of plastic, and in particular is produced in a moulding process. Such nozzle inserts can be produced cost-effectively and with very high accuracy in particular in mass production.

A further, particularly preferred embodiment of the invention is characterized in that a valve which can be controlled via the pressure of the cleaning liquid is arranged in the nozzle body, said valve having one input, which can be connected to a conveying pump for conveying the cleaning liquid, and at least two outputs, wherein each output is connected to an inlet of the receiving device. This affords the advantage that the cleaning liquid is fed to different outputs, and thus to different inlets of the receiving device, depending on the pressure at the input of the valve. Various jet forms of the cleaning liquid can thereby be produced in a pressure-controlled manner.

Advantageously, the valve connects the input to one output when a low pressure is applied and connects the input to another output when a high pressure is applied.

In order to achieve a non-return valve position, it is conceivable that, in a basic position, the valve separates the input from all outputs. The basic position is advantageously a zero pressure position.

The object mentioned above is moreover achieved by a washing system which comprises a conveying pump for the cleaning liquid and a nozzle according to the invention which is connected to the conveying pump via a line.

It is advantageous if the conveying pump delivers the cleaning liquid in a controlled manner at varying pressure, in particular a low pressure or a high pressure.

Advantageously, the pressure of the conveying pump is controlled as a function of the vehicle speed. By way of example, at a vehicle speed of less than 80 km/h, a low pressure can be produced which is for example between 0.2 and 1.4 bar. If the vehicle speed increases to more than 80 km/h, the pressure of the cleaning liquid achieved by the conveying pump is increased for example to 1.4 bar or more. At a relatively low speed or at a relatively low pressure, the output of the valve is advantageously opened and this leads to a flat jet being produced. At a vehicle speed of more than 80 km/h, the inlet is advantageously activated and this leads to one or more punctiform jets being produced.

Further advantageous details and refinements of the invention can be found in the following description in which the invention is described and explained in more detail on the basis of the illustrated examples of embodiments.

In the figures:

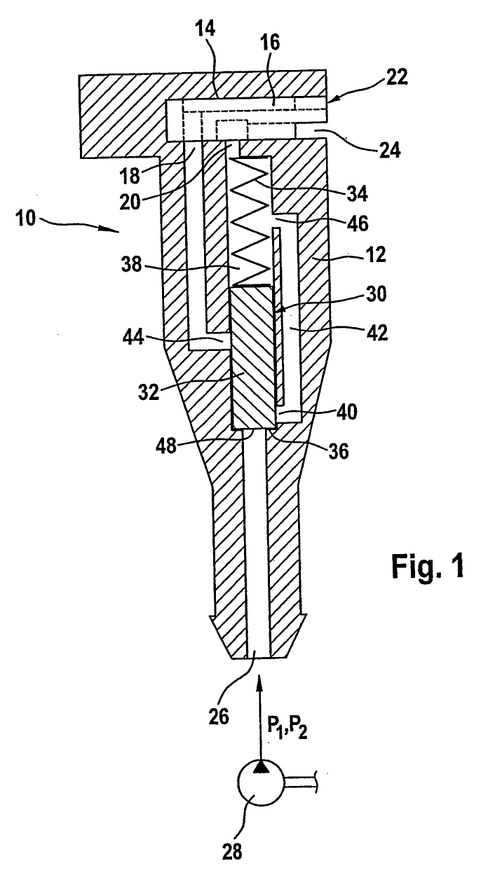

FIG. 1 shows a nozzle according to the invention in longitudinal section; and

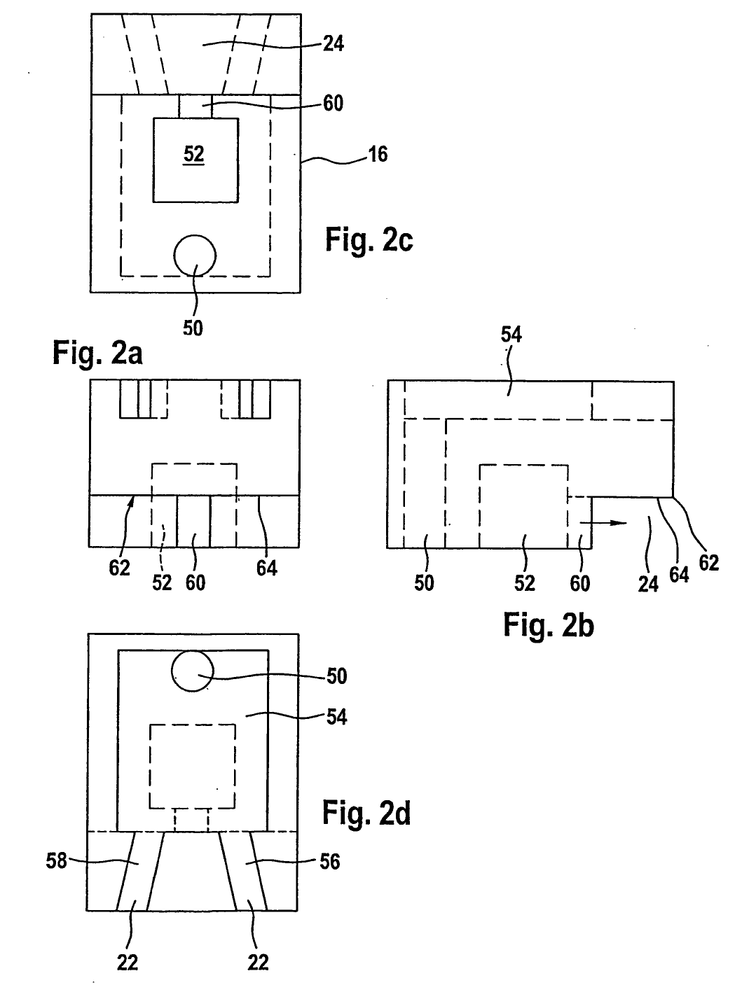

FIGS. 2a-2d show four different views of a nozzle insert of a nozzle according to the invention.

FIG. 1 shows a nozzle 10 according to the invention. The nozzle 10 comprises a nozzle body 12 which has a receiving device 14. A nozzle insert 16 is inserted into the receiving device 14. The nozzle insert 16 can be supplied with cleaning liquid via two inlets 18, 20. Depending on the inlet 18, 20 via which cleaning liquid passes into the receiving device 14 or to the nozzle insert 16, the jet forms of the liquid jets leaving nozzle openings 22, 24 of the nozzle 10 are influenced differently. The specific design of the nozzle insert and the manner in which the cleaning liquid passes from the inlets 18, 20 to the nozzle openings 22, 24 will be explained in the description of FIG. 2.

The nozzle body 12 has an input 26 which can be connected to a schematically shown conveying pump 28. The conveying pump delivers the cleaning liquid at varying pressures, namely at a low pressure P₁ and at a high pressure P₂. The low pressure P₁ is advantageously between 0.2 and 1.4 bar. The high pressure P₂ is advantageously above 1.4 bar. It is conceivable that the conveying pump 28 can be controlled as a function of the vehicle speed. In this case, it may be provided that at vehicle speeds of less than 80 km/h the pump delivers the cleaning liquid at the pressure P₁ and at vehicle speeds of more than 80 km/h at the high pressure P₂.

A pressure-controlled valve 30 is integrated in the nozzle body 12, said valve comprising a cylindrical valve body 32. The valve body 32 is acted upon in the axial direction by the spring force of a spring element 34 against a valve seat 36. In the illustrated basic position of the valve 30, in which the cleaning liquid is present at the input 26 without any pressure, the two inlets 18, 20 are separated from the input 26. The valve body 30, which is mounted in a cylindrical cut-out 38 such that it can be displaced axially counter to the spring force, has a total of three switching positions. The basic position is shown in FIG. 1. When a low pressure P₁ is applied to the cleaning liquid at the input 26, the valve body 32 moves counter to the spring force of the spring 34 until the input 40 of a bypass 42 is opened. A connection 44 which connects the inlet 18 to the cylindrical cut-out 38 remains closed. The bypass 42 opens via its output 46 into the region of the cylindrical cut-out 38 facing the inlet 20. The spring force of the spring element 34 is in this case designed such that, when a low pressure P₁ is applied, a force equilibrium prevails between the spring force and the force resulting from the cleaning liquid hitting the end face 48 of the valve body 32. In this low-pressure position, the cleaning liquid consequently flows exclusively via the bypass 42 and inlet 20 into the receiving device 14.

When the pressure of the cleaning liquid is increased to the high pressure P₂, the valve body 30 is displaced further counter to the spring force, as a result of which on the one hand the connection 44 is connected to the input 26 and on the other hand the bypass output 46 is separated from the inlet 20. As a result, cleaning liquid flows exclusively via the input 26, the connection 44 and the inlet 18 into the receiving device 14.

The valve 30 integrated in the nozzle 10 has the advantage that it manages with only one valve body or piston valve element 30. The cylindrical cut-out 38 has a total of five connections, namely the input 26, the bypass input 40, the bypass output 46, the inlet 20 and the connection 44. Depending on the axial position of the valve body 32, cleaning liquid can pass via the input 26 to the inlets 18 or 20. The axial spacing of the bypass input 40 from the bypass output 46 is such that it is somewhat greater than the axial longitudinal extent of the valve body 32. This ensures that flowing round the valve body 32 via the bypass 42 is possible. Moreover, the axial spacing of the connection 44 and of the bypass output 46 is such that it is slightly smaller than the axial longitudinal extent of the valve body 32. This ensures that the output 46 is closed before the connection 44 is opened, as a result of which a pressure drop on account of the connection 44 and the inlet 20 being open at the same time cannot occur. As a result of the fact that the input 26 and the inlet 20 lie along an axis in which the valve body 32 also lies, the nozzle 10 is very compact in the axial direction.

FIG. 2 shows the nozzle insert 16 as an individual part in various views. FIG. 2a shows the front view and FIG. 2b shows a side view corresponding to FIG. 1. FIG. 2c shows the view from below and FIG. 2d shows the plan view of the nozzle insert 16.

The nozzle insert 16 has a liquid feed 50 which can be connected to the inlet 18 and a liquid feed 52 which can be connected to the inlet 20. The feed 50 is designed as a hole extending through the nozzle insert 16, as can be seen in particular in FIGS. 2c and 2d. On the side facing away from the inlets 18, 20 in the assembled state, the nozzle insert 16 has a depression 54 which has a rectangular bottom surface. The feed 50 opens into this depression 54. In the assembled state, the depression 54 together with the wall of the receiving device 14 facing the depression 54 forms a whirl chamber. Two groove-like notches 56, 58 which are arranged at an acute angle to one another and open into a respective nozzle opening 22 extend out from the depression 54. Together with the wall facing the depression 54, the notches 56, 58 form jet guides which serve to produce two punctiform jets. If the inlet 18 or the feed 50 is then supplied with cleaning liquid, this flows through the whirl chamber formed by the depression 54 and the jet guides formed by the notches 58, 56 and leaves the nozzle 10 through the nozzle openings 22 in the form of punctiform jets.

As can be seen in particular from FIGS. 2b and 2c, the feed 52, which in the assembled state is in contact with the inlet 20, also forms a whirl chamber. Adjoining the feed or whirl chamber is a hole 60 which opens into the nozzle opening 24. Adjoining the nozzle opening 24 is a guide surface 64 which runs parallel to the jet direction and opens into a break-away edge 62.

When the inlet 20 is open, cleaning liquid is then whirled in the whirl chamber 52 and guided via the hole 60 along the guide surface 64 until it finally breaks away at the break-away edge 62 as a flat jet. As can be seen in particular from FIG. 2a, the guide surface 64 extends over the entire width of the nozzle insert 16.

The nozzle insert 16 is designed such that the cleaning liquid coming from the inlet 18 does not mix with the cleaning liquid coming from the inlet 20 within the receiving device 14.

The nozzle insert 16 is designed as a plastic injection-moulded part. Depending on the requirement in terms of jet form or the vehicle windscreen, various inserts may be used on the same nozzle body. This has the advantage that the nozzle body 12 can be produced in large numbers. Depending on the field of use, only a different nozzle insert has to be provided. By way of example, it is conceivable to provide only one notch instead of two notches 56, 58, so that one punctiform jet instead of two is produced. It is furthermore conceivable to permanently close one inlet 18, 20 by means of the nozzle insert so that only one jet form is produced.

All features shown in the description, the claims and the drawing may be essential to the invention both individually and in any desired combination.

1. A nozzle for a washing system in particular for vehicle windscreens, comprising a nozzle body with a receiving device provided in the nozzle body, into which receiving device a nozzle insert is or can be inserted, wherein the nozzle insert influences the jet form a liquid jet leaving the nozzle, characterized in that the receiving device has at least two inlets for the cleaning liquid and in that the nozzle insert is designed such that it influences the cleaning liquid coming from one inlet in a different manner from the cleaning liquid coming from another inlet.

2. The nozzle according to claim 1, characterized in that the nozzle body can be fitted with different nozzle inserts during assembly of the nozzle.

3. The nozzle according to claim 1, characterized in that the nozzle insert influences the cleaning liquid coming from at least one inlet such that one or more punctiform jet forms can be produced.

4. The nozzle according to claim 1, characterized in that the nozzle insert influences the cleaning liquid coming from at least one inlet such that one or more flat, curved and/or conical jet forms can be produced.

5. The nozzle according to claim 1, characterized in that the nozzle insert blocks the cleaning liquid coming from one inlet ( ).

6. The nozzle according to claim 1, characterized in that the nozzle insert is designed such that the cleaning liquid coming from one inlet does not mix with the cleaning liquid coming from the other inlet.

7. The nozzle according to claim 1, characterized in that the nozzle insert together with at least one wall of the receiving device facing said insert forms a chamber which influences and/or guides the cleaning liquid.

8. The nozzle according to claim 7, characterized in that the chamber is a whirl chamber and/or a jet guide.

9. The nozzle according to claim 1, characterized in that the nozzle insert together with a wall of the receiving device facing said insert forms a whirl chamber connected to an inlet and at least one jet guide to a first nozzle opening.

10. The nozzle according to claim 1, characterized in that the nozzle insert on one side has a whirl chamber with a jet guide, and in that the nozzle insert on another side, in particular on the side opposite the first side, has a second whirl chamber with a second jet guide, wherein the first whirl chamber is connected to a first inlet and the second whirl chamber is connected to a second inlet.

11. The nozzle according to claim 1, characterized in that the nozzle insert has a breakaway edge, in particular for producing a flat jet.

12. The nozzle according to claim 1, characterized in that the inlets in the receiving device run essentially perpendicular to the main jet direction of the jet forms to be produced.

13. The nozzle according to claim 1, characterized in that the nozzle insert has essentially a cuboid shape.

14. The nozzle according to claim 1, characterized in that the nozzle insert is made of plastic, and in particular is produced in a moulding process.

15. The nozzle according to claim 1, characterized in that a valve which can be controlled via the pressure of the cleaning liquid is arranged in the nozzle body, said valve having one input, which can be connected to a conveying pump for conveying the cleaning liquid, and at least two outputs, wherein each output is connected to an inlet of the receiving device.

16. The nozzle according to claim 15, characterized in that, when a low pressure is applied, the valve connects the input to the first output and/or to the other output.

17. The nozzle according to claim 16, characterized in that, when a high pressure is applied, the valve connects the input to the other or to the first output.

18. The nozzle according to claim 15, characterized in that, in a basic position, the valve separates the input from all outputs.

19. The washing system comprising a conveying pump for the cleaning liquid and a nozzle according to claim 1 which is connected to the conveying pump via a line.

20. The washing system according to claim 19, characterized in that the conveying pump delivers the cleaning liquid in a controlled manner with varying pressure.

21. The washing system according to claim 18, characterized in that the pressure of the conveying pump is controlled as a function of the vehicle speed.

22. The nozzle according to claim 2, characterized in that the nozzle insert influences the cleaning liquid coming from at least one inlet such that one or more punctiform jet forms van be produced

23. The nozzle according to claim 16, characterized in that, in a basic position, the valve separates the input from all outputs.

24. The nozzle according to claim 17, characterized in that, in a basic position, the valve separates the input from all outputs.

25. The washing system according to claim 19, characterized in that the pressure of the conveying pump is controlled as a function of the vehicle speed.
